(19) United States
(12) Patent Application Publication
(10) Pub. No.: US 2020/0171677 A1
(43) Pub. Date: Jun. 4, 2020

(54) HAND MECHANISM AND GRIPPING SYSTEM

(71) Applicant: THK CO., LTD., Tokyo (JP)

(72) Inventor: Yoshimasa Endo, Minato-ku, Tokyo (JP)

(73) Assignee: THK CO., LTD., Tokyo (JP)

(21) Appl. No.: 16/636,414

(22) PCT Filed: Aug. 7, 2018
(86) PCT No.: PCT/JP2018/029612

§ 371 Date: Feb. 4, 2020

(30) Foreign Application Priority Data
Aug. 10, 2017 (JP) 2017-155981

(51) Int. Cl. B25J 15/10; B25J 13/08

(52) U.S. Cl. CPC B25J 15/10; B25J 13/082

(57) ABSTRACT

In a configuration in which a plurality of pressure sensors axe arranged on each finger portion of a hand mechanism, a state of contact between the finger portion and an object, a contact position in which the finger portion contacts the object, and so on are recognized more accurately. In a hand mechanism that includes a plurality of finger portions and grips an object using the finger portions, a plurality of pressure sensors are mounted on the outer surface of each finger portion, and two adjacent pressure sensors, among the plurality of pressure sensors, are arranged close to each other. Further, a flexible cover formed from a flexible, membranous member is attached to each finger portion so as to cover the plurality of pressure sensors. According to this configuration, even when the object contacts a dead zone, contact between the finger portion and the object can be detected accurately.

### TECHNICAL FIELD

The present invention relates to a hand mechanism for gripping an object using a plurality of fingers, and a gripping system.

### BACKGROUND ART

A hand mechanism attached to a robot arm or the like in order to grip an object using a plurality of fingers has been developed conventionally. For example, PTL 1 discloses a hand mechanism having three finger portions (fingers). In the hand mechanism of PTL 1, the three finger portions are structured identically. Further, in the hand mechanism of PTL 1, a plate member is provided on a tip end portion of each finger portion, the plate member having a free end that projects from the tip end portion. By configuring the finger portion in this manner, when an object placed on a flat surface is to be gripped by the hand mechanism, the object can be gripped by the finger portions by inserting the plate members of the finger portions between the flat surface and the object.

### CITATION LIST

### Patent Literature

[PTL 1] Japanese Translation of PCT Application No. 2015-533669

### SUMMARY OF INVENTION

### Technical Problem

When an object is to be gripped by a hand mechanism, it is important to accurately recognize the state of contact between the finger portions and the object accurately. In response to this requirement, a method of mounting a plurality of pressure sensors on the finger portions of the hand mechanism in order to detect the state of contact, the contact position, and so on between the finger portions and the object may be employed. With this method, however, when the object is in contact with a gap between two adjacent pressure sensors so that the object is not in contact with either of the two pressure sensors, the resulting state of contact cannot be detected by the pressure sensors, and as a result, it may be difficult to grip the object in an appropriate attitude.

The present invention has been designed in consideration of the circumstances described above, and an object thereof is to provide a technique for a configuration in which a plurality of pressure sensors are arranged on the finger portions of a hand mechanism, with which a state of contact between the finger portions and an object can be recognized more accurately.

### Solution to Problem

A hand mechanism according to the present invention includes a plurality of finger portions and grips an object using the finger portions. A plurality of pressure sensors are mounted on an outer wall surface of at least one of the plurality of finger portions, and a membranous flexible cover is attached to the outer wall surface of the at least one finger portion so as to cover the plurality of pressure sensors.

### Advantageous Effects of the Invention

According to the present invention, in a configuration in which a plurality of pressure sensors are arranged on the finger portions of a hand mechanism, a state of contact between the finger portions and an object can be recognized more accurately.

### BRIEF DESCRIPTION OF DRAWINGS

FIG. 1 is a schematic view showing a configuration of a robot arm according to a first embodiment.

FIG. 2 is a perspective view of a hand mechanism according to the first embodiment.

FIG. 3 is a top view of the hand mechanism according to the first embodiment.

FIG. 4 is a side view of a finger portion of the hand mechanism according to the first embodiment.

FIG. 5 is a view showing a tip end portion side of the finger portion of the hand mechanism according to the first embodiment from the direction of an arrow A in FIG. 4.

FIG. 6 is a view showing an internal structure of a part of a base portion near a connecting portion connected to the finger portion and internal structures of a base end portion and a second joint portion of the finger portion on the hand mechanism according to the first embodiment.

FIG. 7 is a view showing a movement range of the second joint portion of the finger portion on the hand mechanism according to the first embodiment.

FIG. 8 is a view showing internal structures of a first joint portion and a second finger link portion of the finger portion on the hand mechanism according to the first embodiment.

FIG. 9 is a view showing a movement range of the first joint portion of the finger portion on the hand mechanism according to the first embodiment.

FIG. 10 is a first view showing an arrangement of pressure sensors on a first finger link portion of the finger portion on the hand mechanism according to the first embodiment.

FIG. 11 is a second view showing the arrangement of the pressure sensors on the first finger link portion of the finger portion on the hand mechanism according to the first embodiment.

FIG. 12 is a schematic view showing the configuration of the pressure sensor.

FIG. 13 is a view showing an arrangement of sensor elements in a case where two pressure sensors are arranged close to each other.

FIG. 14 is a view showing an example of a method for attaching a flexible cover according to the first embodiment to the first finger link portion.

FIG. 15A is a view showing a state in which two pressure sensors arranged close to each other are covered by the flexible cover.

FIG. 15B is a view showing a state in which a dead zone covering portion of the flexible cover is in contact with an object but a sensor element covering portion of the flexible cover is not in contact with the object.

FIG. 16 is a block diagram showing function units included respectively in an arm control device and a hand control device according to the first embodiment.

FIG. 17 is a view showing an example of the shape of an object gripped by the hand mechanism.

FIG. 18 is a view showing a state in which a plurality of objects are arranged side by side.

FIG. 19 is a first view showing an operation performed to alter the attitude of the object using a first finger portion of the hand mechanism according to the first embodiment.

FIG. 20 is a second view showing the operation performed to alter the attitude of the object using the first finger portion of the hand mechanism according to the first embodiment.

FIG. 21 is a first view showing a state in which the object has been gripped by a second finger portion, a third finger portion, and a fourth finger portion of the hand mechanism according to the first embodiment.

FIG. 22 is a second view showing a state in which the object has been gripped by the second finger portion, the third finger portion, and the fourth finger portion of the hand mechanism according to the first embodiment.

FIG. 23 is a view showing a state in which a thin object has been gripped by the second finger portion, the third finger portion, and the fourth finger portion of the hand mechanism according to the first embodiment.

FIG. 24 is a view showing a state in which a flexible cover according to a second embodiment is placed on the first finger link portion.

FIG. 25 is a perspective view showing a configuration of an abdominal portion of the first finger link portion according to the second embodiment.

FIG. 26 is a perspective view showing a configuration of a back portion of the first finger link portion according to the second embodiment.

FIG. 27 is a front view of the flexible cover according to the second embodiment.

FIG. 28 is a view showing an example of a method for attaching a protective cover to the first finger link portion according to another embodiment.

FIG. 29 is a view showing a state in which two pressure sensors arranged close to each other are covered by a flexible cover and a protective cover, according to another embodiment.

### DESCRIPTION OF EMBODIMENTS

A hand mechanism according to the present invention includes a plurality of finger portions, and a plurality of pressure sensors are mounted on at least one of the plurality of finger portions. Here, the pressure sensor is typically formed by disposing a sensor element on the surface of a sheet-form base material, the sensor element being smaller than the base material, and covering the surface and periphery of the sensor element with an insulating film. In a case where a plurality of the pressure sensors thus structured are mounted on each finger portion, even when two adjacent sensors are arranged close to each other, a gap (referred to hereafter as a “dead zone”) of a size corresponding to the base material that extends around each of the sensor elements is formed between the sensor elements of the respective pressure sensors. Therefore, in a state where an object contacts the dead zone but does not contact the sensor elements, it may be impossible to detect a state of contact between the finger portion and the object. A method of mounting a single pressure sensor with a large sensitive area on the finger portion may be employed, but in this case, it may be difficult to specify the contact position in which the finger portion contacts the object.

In the hand mechanism according to the present invention, therefore, a membranous flexible cover for covering the plurality of pressure sensors is attached to the finger portion. According to this configuration, in a state where a site (also referred to hereafter as a “dead zone covering portion”) of the flexible cover that covers the dead zone contacts the object but a site (also referred to hereafter as a “sensor element covering portion”) of the flexible cover that covers the surfaces of, the sensor elements does not contact the object, the flexible cover yields while pressing at least one of the two sensor elements respectively positioned adjacent to the dead zone. As a result, the state of contact between the finger portion and the object can be detected accurately.

Specific embodiments of the present invention will be described below on the basis of the figures. Unless specified otherwise, the technical scope of the invention is not limited only to the dimensions, materials, shapes, relative arrangements, and so on of the constituent components described in these embodiments.

### First Embodiment

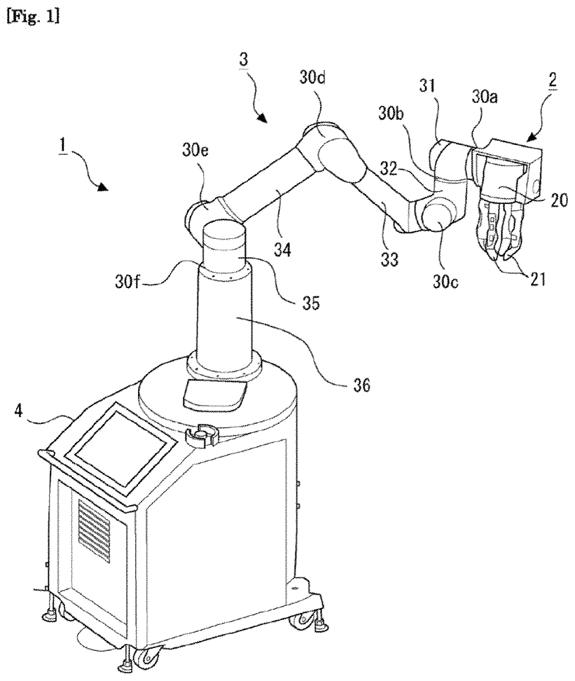

A first embodiment of the present invention be described on the basis of FIGS. 1 to 23. Here, a case in which the hand mechanism and gripping system according to the present invention are applied to a robot arm will be described. FIG. 1 is a schematic view showing a configuration of the robot arm according to this embodiment. A robot arm 1 includes a hand mechanism 2, an arm mechanism 3, and a support portion 4. The hand mechanism 2 is attached to one end of the arm mechanism 3. Further, the other end of the arm mechanism 3 is attached to the support portion 4. The hand mechanism 2 includes a base portion 20 connected to the arm mechanism 3, and four finger portions 21 provided on the base portion 20. Note that the configuration of the hand mechanism 2 will be described in detail below.

### Arm Mechanism

The arm mechanism 3 includes a first arm link portion 31, a second arm link portion 32, a third arm link portion 33, a fourth arm link portion 34, a fifth arm link portion 35, and a connecting member 36. The base portion 20 of the hand mechanism 2 is connected to a first joint portion 30a formed on one end side of the first arm link portion 31 of the arm mechanism 3. A motor (not shown) for rotating the hand mechanism 2 relative to the first arm link portion 31 about the first arm link portion 31 is provided in the first joint portion 30a. The other end side of the first, arm link portion 31 is connected to one end side of the second arm link portion 32 by a second joint portion 30b. The first arm link portion 31 and the second arm link portion 32 are connected so that respective central axes thereof intersect perpendicularly. A motor (not shown) for rotating the first arm link portion 31 relative to the second arm link portion 32 about the other end side thereof is provided in the second joint portion 30b. The other end side of the second arm link portion 32 is connected to one end side of the third arm link portion 33 by a third joint portion 30c. A motor (not shown) for rotating the second arm link portion 32 relative to the third arm link portion 33 is provided in the third joint portion 30c.

Similarly the other end side of the third arm link portion 33 is connected to one end side of the fourth arm link portion 34 by a fourth joint portion 30d. The other end side f the fourth arm link portion 34 is connected to the fifth arm link portion 35 by a fifth joint portion 30e. A motor (not shown) for rotating the third arm link portion 33 relative to the fourth arm link portion 34 is provided in the fourth joint portion 30d. Moreover, a motor (not shown) for rotating the fourth arm link portion 34 relative to the fifth arm link portion 35 is provided in the fifth joint portion 30e. Further, the fifth arm link portion 35 is connected to the connecting member 36, which is disposed to extend vertically from the support portion 4, by a sixth joint portion 30f. The fifth arm link portion 35 and the connecting member 36 are connected so that respective central axes thereof are coaxial. A motor (not shown) for rotating the fifth arm link portion 35 about the fifth arm link portion 35 and the connecting member 36 is provided in the sixth joint portion 30f. By configuring the arm mechanism 3 in this manner, for example, the arm mechanism 3 can be realized as a mechanism having six degrees of freedom.

### Hand Mechanism

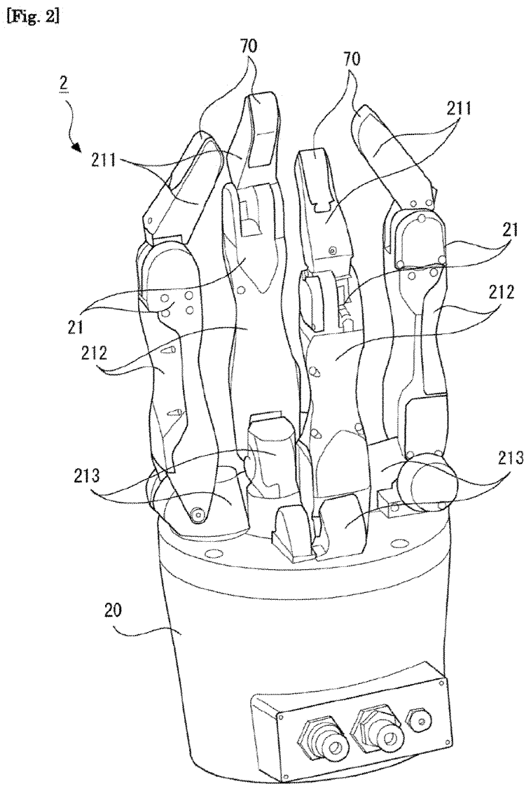

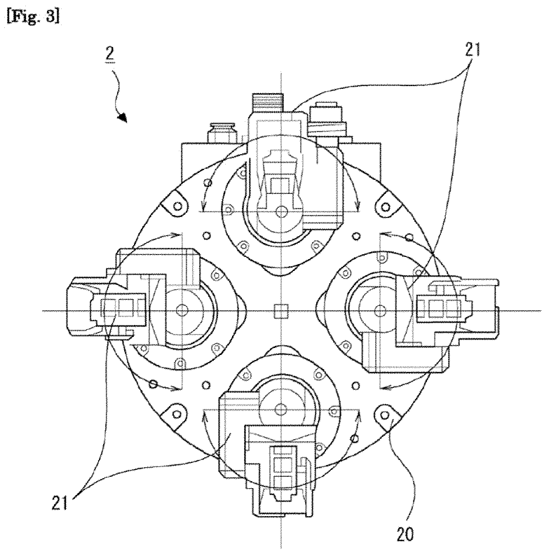

Next, the configuration of the hand mechanism 2 will be described on the basis of FIGS. 2 to 15. FIG. 2 is a perspective view of the hand mechanism 2, and FIG. 3 is a top view of the hand mechanism 2. Note that in FIG. 3, the arrows denote rotary movement ranges of the respective finger portions 21. As shown in FIGS. 2 and 3, in the hand mechanism 2, the four finger portions 21 are disposed on the base portion 20 at equal angular intervals (more specifically, at 90 degree intervals) on a circumference centering on a longitudinal direction (a perpendicular direction to the paper surface in FIG. 3) axis of the hand mechanism 2. Further, the four finger portions 21 all have identical structures and identical lengths. Note, however, that the operations of the respective finger portions 21 are controlled independently.

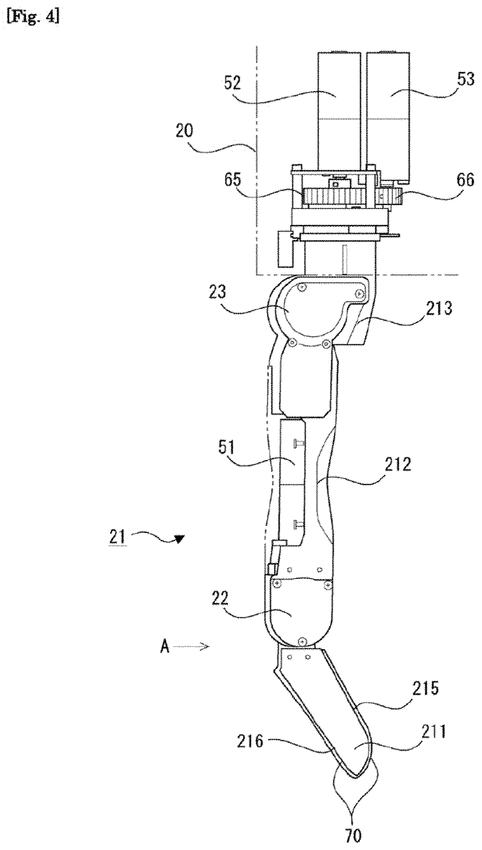

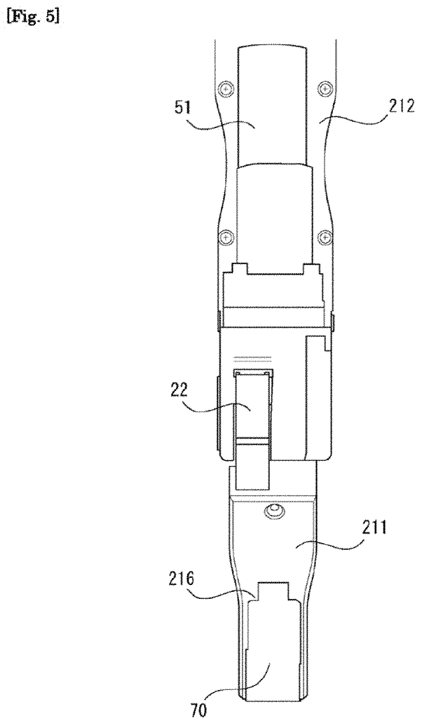

FIGS. 4 to 15 are views illustrating the configuration of one finger portion 21 of the hand mechanism 2 and a driving mechanism thereof. FIG. 4 is a side view of the finger portion 21. Note that in FIG. 4, the base portion 20 is depicted in a see-through state so that the part of the internal structure of the finger portion 21 positioned inside the base portion 20 can also be seen. Further, FIG. 5 is a view showing a tip end portion side of the finger portion 21 from the direction of an arrow A in FIG. 4. Note that in FIGS. 4 and 5, a part of a second finger link portion 212 of the finger portion 21, to be described below, is depicted in a see-through state so that the internal structure of the second finger link portion 212 can also be seen.

As shown in FIGS. 2 and 4, each finger portion 21 includes a first finger link portion 211, the second finger link portion 212, and a base end portion 213. The base end portion 213 of the finger portion 21 is connected to the base portion 20. Here, as indicated by arrows in FIG. 3, the base end portion 213 is connected to the base portion 20 so as to be capable of rotating relative to the base portion 20 about a longitudinal direction (a perpendicular direction to the paper surface in FIG. 3) axis of the finger portion 21. Further, on the finger portion 21, one end of the second finger link portion 212 is connected to the base end portion 213. A second joint portion 23 is formed in a connecting portion between the second finger link portion 212 and the base end portion 213.

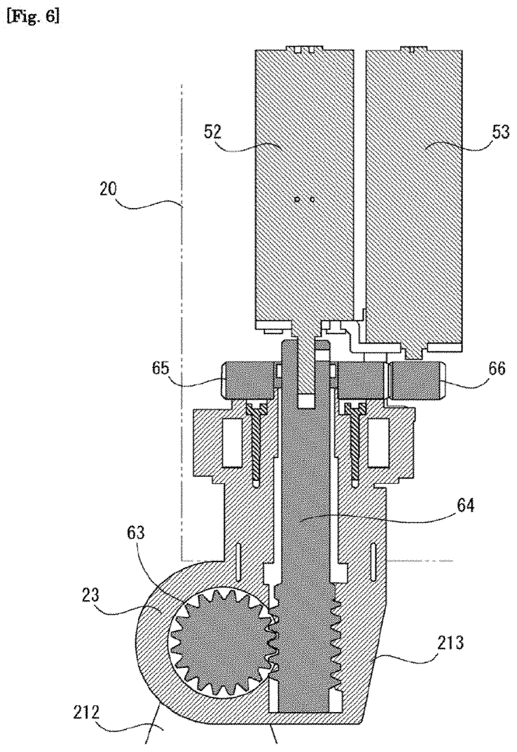

Now, a driving mechanism of the base end portion 213 and a driving mechanism of the second joint portion 23 will be described on the basis of FIG. 6. FIG. 6 is a view showing an internal structure of a part of the base portion 20 near a connecting portion connected to the finger portion 21 and internal structures of the base end portion 213 and the second joint portion 23 of the finger portion 21. As shown in FIG. 6, a gear 65, a gear 66, a second motor 52, and a third motor 53 are provided in the interior of the base portion 20. The gear 65 is a gear for rotating the entire finger portion 21 and is connected to a rotary shaft of the base end portion 213. The gear 66 is connected to a rotary shaft of the third motor 53. The gear 65 and the gear 66 are meshed with each other. With this configuration, when the third motor 53 rotates, resulting rotary force is transmitted to the rotary shaft of the base end portion 213 through the two gears 65, 66. As a result, the base end portion 213 is driven to rotate, whereby the entire finger portion 21 is driven to rotate within a range indicated by the arrows in FIG. 3.

Further, a worm wheel 63 and a worm 64 meshed with the worm wheel 63 are provided in the interior of the second joint portion 23. The worm wheel 63 is connected to a rotary shaft of the second finger link portion 212 in the second joint portion 23. Furthermore, the worm 64 is connected to a rotary shaft of the second motor 52 provided in the interior of the base portion 20. According to this configuration, when the second motor 52 is driven to rotate, resulting rotary force is transmitted to the rotary shaft of the second finger link portion 212 by the worm 64 and the worm wheel 63. As a result, the second finger link portion 212 is driven to rotate relative to the base end portion 213. Here, FIG. 7 is a view showing a movement, range of the second joint portion 23 of the finger portion 21, this movement range being realized by the driving force of the second motor 52. As shown in FIG. 7, the second joint portion 23 is formed to be capable of bending and extending Note that the driving force generated by the second motor 52 and the driving force generated by the third motor 53 are transmitted to the respective operation subjects thereof independently.

Furthermore, as shown in FIGS. 4 and 5, in the finger portion 21, one end of the first finger link portion 211 is connected to the other end of the second finger link portion 212. A first joint portion 22 is formed in a connecting portion between the first finger link portion 211 and the second finger link portion 212.

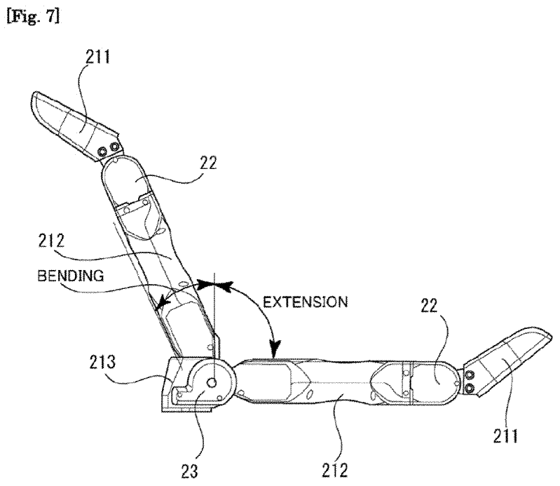

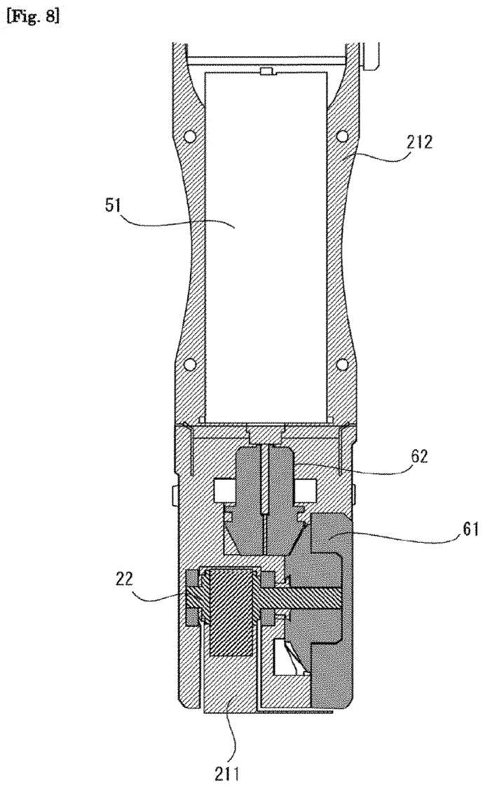

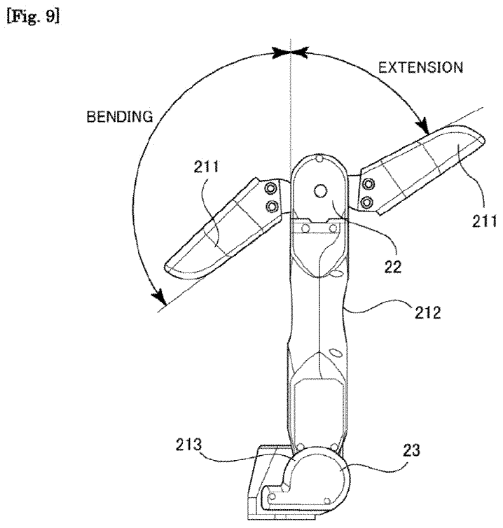

Here, a driving mechanism of the first joint portion 22 will be described on the basis of FIG. 8. FIG. 8 is a view showing internal structures of the first joint portion 22 and the second finger link portion 212 in the finger portion 21. Intermeshed bevel gears 61, 62 meshed with each other are provided in the interior of the first joint portion 22. One of the bevel gears 61 is connected to a rotary shaft of the first finger link portion 211 within the first joint portion 22. Further, the other bevel gear 62 is connected to a rotary shaft of a first motor 51 provided in the interior of the second finger link portion 212. With this configuration, when the first motor 51 is driven to rotate, resulting rotary force is transmitted to the rotary shaft of the first finger link portion 211 by the two bevel gears 61, 62. As a result, the first finger link portion 211 is driven to rotate relative to the second finger link portion 212. Here, FIG. 9 is a view showing a movement range of the first joint portion 22 of the finger portion 21, realized by the driving force of the first motor 51. As shown in FIG. 9, the first joint portion 22 is formed to be capable of being bent and extended.

Furthermore, as shown in FIGS. 2 and 4, in this embodiment, in the finger portion 21, the second finger link portion 212 on the base portion 20 side (the base end portion 213 side) of the first joint portion 22 is longer than the first finger link portion 211 on the tip end portion side of the first joint portion 22.

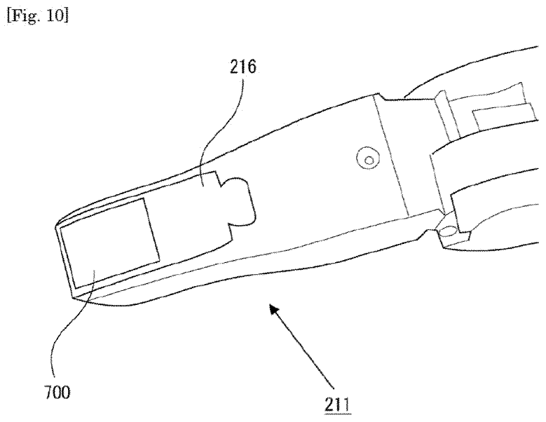

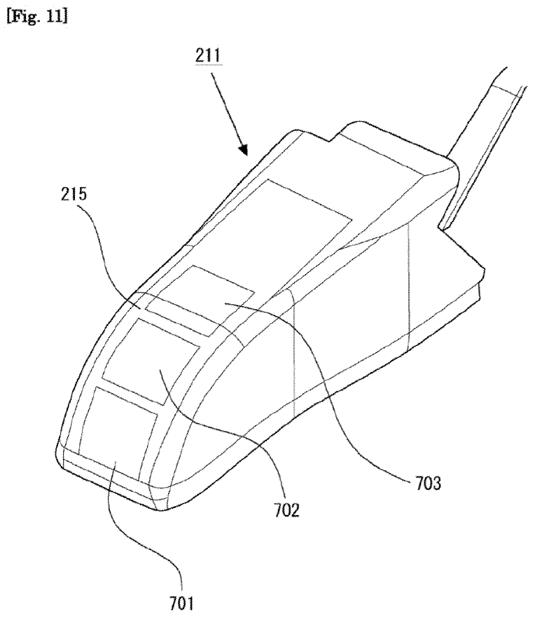

Moreover, as shown in FIGS. 2, 4, and 5, in this embodiment, pressure sensors 70 are mounted on the tip end portion side of the first finger link portion 211 of the finger portion 21. More specifically, as shown in FIGS. 10, 11, and 14, four pressure sensors 700, 701, 702, 703 (also referred to collectively hereafter as “the pressure sensors 70”) are arranged on the first finger link portion 211 in a straight line in the longitudinal direction of the first finger link portion 211 from a back portion (in other words, a bending direction-side wall surface of the first joint portion 22 (also referred to hereafter as the “bending-side wall surface”)) 215 to an abdominal portion tin other words, an extending direction-side wall surface (also referred to hereafter as the “extending-side wall surface”)) 216. In the example shown in FIGS. 10 and 11, one pressure sensor 700 is arranged on the extending-side wall surface 216, and the remaining three pressure sensors 701, 702, 703 are arranged on the bending-side wall surface 215 so as to extend in the longitudinal direction from the tip end portion side toward the base end portion side. Note that the method for arranging the pressure sensors 70 is not limited to a method of arranging the pressure sensors 70 in a straight line in the longitudinal direction of the first finger link portion 211, and the pressure sensors 70 may be arranged in a straight line in a latitudinal direction of the first finger link portion 211 or arranged in an oblique direction relative to the longitudinal direction or the latitudinal direction of the first finger link portion 211. Further, in the example shown in FIGS. 10, 11, and 14, the four pressure sensors 700, 701, 702, 703 are arranged in a single row, but the four or more pressure sensors may be arranged in two or more rows, or the four or more pressure sensors 70 may be arranged in a staggered arrangement. Furthermore, the number of pressure sensors arranged on the extending-side wall surface 216 is not limited to one, and two or more pressure sensors may be arranged on the extending-side wall surface 216. Similarly, the number of pressure sensors arranged on the bending-side wall surface 215 is not limited to three, and two pressure sensors or four or more pressure sensors may be arranged thereon. In other words, the number and positions of the pressure sensors arranged on the first finger link portion may be determined as appropriate in accordance with the size and shape of the object and so on.

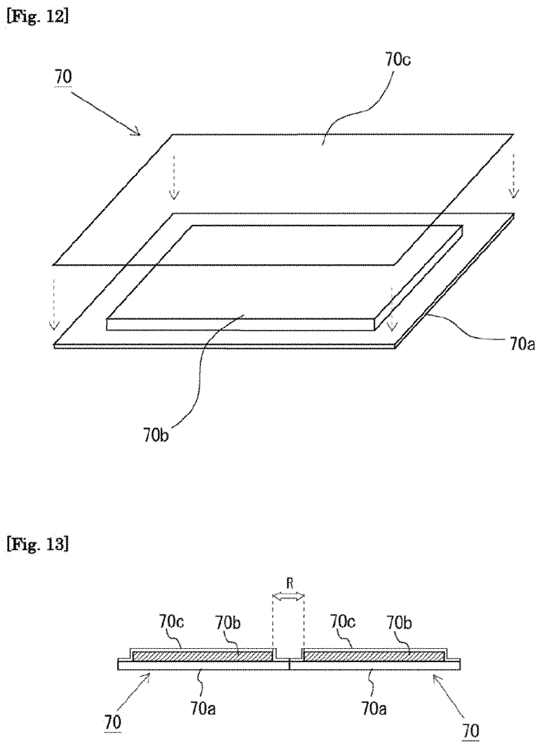

The pressure sensors 70 described above are sensors for detecting external force (pressure) acting on the first finger link portion 211. As shown in FIG. 12, for example, each of the pressure sensors 70 is formed by disposing a sensor element 70b in a substantially central portion of the surface of a base material 70a formed from a rectangular sheet, the sensor element 70b being smaller than the base material 70a, and covering the surface of the sensor element 70b and the surface of the base material 70a extending around the sensor element 70b with an insulating film 70c. Note that any type of well-known sensor element, such as a piezoelectric sensor element, a strain gauge type sensor element, or an electrostatic capacitance type sensor element, may be used as the sensor element 70b. Further, in the example shown in FIG. 12, the base material 70a, the sensor element 70b, and the insulating film 70c, i.e. the respective constituent elements of the pressure sensor 70, are formed in a rectangular shape, but the shape of these constituent elements is not limited to a rectangular shape and may be altered as appropriate in accordance with the shape of the first finger link portion 211 and so on.

As shown in FIGS. 10 and 11, when the four pressure sensors 700, 701, 702, 703 are mounted on the first finger link portion 211, it is possible to differentiate between a state in which the extending-side wall surface 216 of the first finger link portion 211 is in contact with the object, a state in which a tip end portion of the bending-side wall surface 215 of the first finger link portion 211 is in contact with the object, a state in which an intermediate portion of the bending-side wall surface 215 of the first finger link portion 211 is in contact with the object, and a state in which a base end portion of the bending-side wall surface 215 of the first finger link portion 211 is in contact with the object.

Incidentally, in a case where the plurality of pressure sensors 70 are mounted on the first finger link portion 211 of the finger portion 21, as described above, even when two adjacent pressure sensors 70 are arranged close to each other, a dead zone (the part denoted as R in FIG. 13) of a size corresponding to the base material 70a that extends around each of the sensor elements 70b of the two pressure sensors 70 is formed between the sensor elements 70b, as shown in FIG. 13. Therefore, if a state in which the object contacts the dead zone R and does not contact the sensor elements 70b respectively positioned adjacent to the dead zone R occurs when the object is to be gripped by the hand mechanism 2, it may be impossible to detect contact between the first finger link portion 211 and the object using the pressure sensors 70. In response to this problem, a method of mounting a single, continuous pressure sensor on the first finger link portion 211 so as to extend from the extending-side wall surface 216 to the bending-side wall surface 215 may be employed, but in this case, it is difficult to differentiate between the contact positions in which the first finger link portion 211 contacts the object, as described above. Hence, in this embodiment, a membranous flexible cover for covering the plurality of pressure sensors 70 mounted on the first finger link portion 211 is attached to the finger portion 21 of the hand mechanism 2.

### Flexible Cover

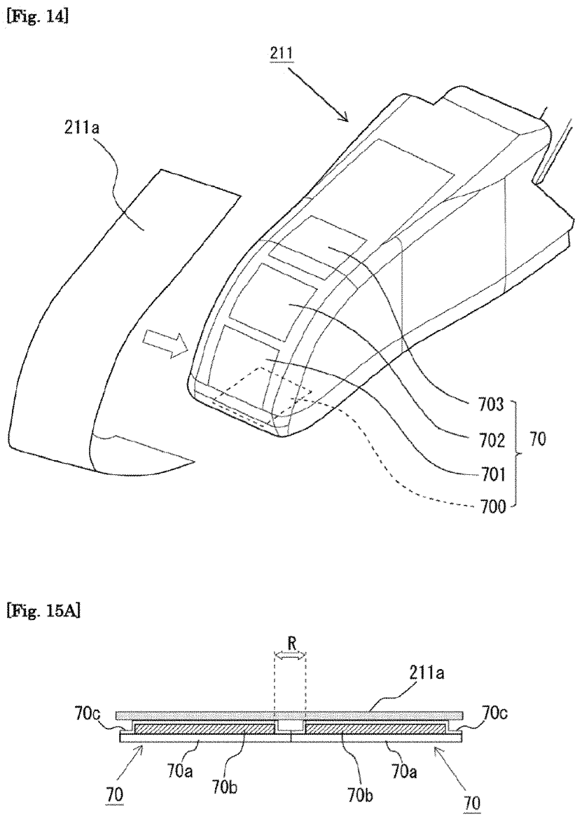

In this embodiment, as shown in FIG. 14, for example, a flexible cover 211a formed in sheet-form is adhered to the first finger link portion 211 so as to extend from the bending-side wall surface 215 to the extending-side wall surface 216. At this time, the size of the flexible cover 211a is set so that the flexible cover 211a can cover the four pressure sensors 700, 701, 702, 703 and the outer wall surface of the first finger link portion 211 on the periphery thereof. Note that the flexible cover 211a may be constituted by either a single sheet or a plurality of connected sheets. In other words, the flexible cover 211a is to be configured so as to be capable of continuously covering the four pressure sensors 700, 701, 702, 703 and the outer wall surface of the first finger link portion 211 on the periphery thereof. When the flexible cover 211a thus configured is adhered to the first finger link portion 211, as shown in FIG. 15A, an inner wall surface of the flexible cover 211a is in close contact with the insulating film 70c covering the surface of the sensor element 70b, while a space is formed between the inner wall surface of the flexible cover 211a and the dead zone R. Therefore, in a state where the site (the dead zone covering portion) of the flexible cover 211a that covers the dead zone R contacts the object but the site (the sensor element covering portion) of the flexible cover 211a that covers the surface of the sensor element 70b does not contact the object, the flexible cover 211a in the vicinity of the dead zone covering portion yields while pressing at least one of the two sensor elements 70b respectively positioned adjacent to the dead zone, as shown in FIG. 15B. As a result, the contact between the dead zone covering portion and the object can be detected by the previously-mentioned at least one of the two sensor elements 70b. Note that polyolefin or the like, for example, can be used as the material of the flexible cover 211a. Further, the flexible cover 211a may be formed from a member in which the friction coefficient of the outer surface of the flexible cover 211a is larger than the respective friction coefficients of the outer wall surface of the first finger link portion 211 and the outer surface of the insulating film 70c.

### Support Portion

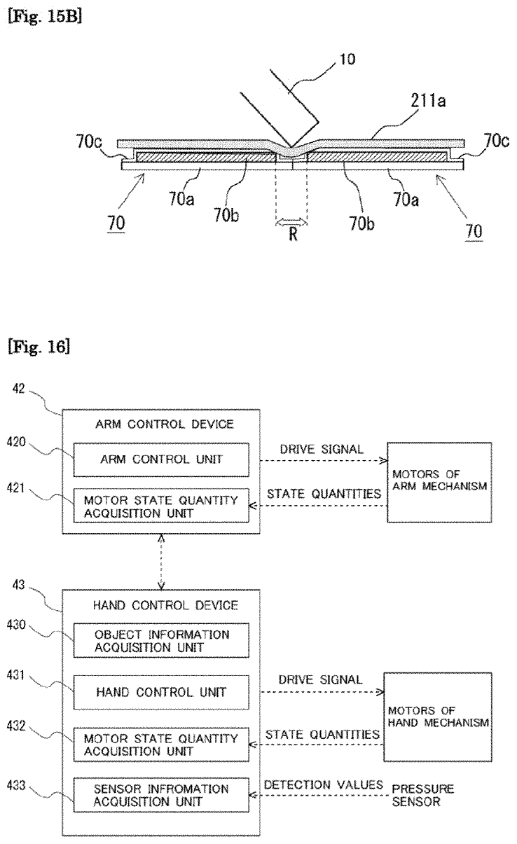

Next, configurations of an arm control device 42 and a hand control device 43 built into the support portion 4 will be described on the basis of FIG. 16. The arm control device 42 is a control device for controlling the arm mechanism 3 of the robot arm 1. The hand control device 43 is a control device for controlling the hand mechanism 2 of the robot arm 1. FIG. 16 is a block diagram showing function units included respectively in the arm control device 42 and the hand control device 43.

The arm control device 42 is configured to include a plurality of drivers that generate drive signals used to drive the motors provided in the respective joint portions of the arm mechanism 3 and to supply the drive signals from the respective drivers to the corresponding motors. The arm control device 42 also includes a computer having an arithmetic processing device and a memory Further, as function units, the arm control device 42 includes an arm control unit 420 and a motor state quantity acquisition unit 421. These function units are formed by executing a predetermined control program in the computer included in the arm control device 42.

The arm control unit 420 controls the motors provided respectively in the joint portions 30a, 30b, 30c, 30d, 30e, 30f of the arm mechanism 3 by supplying the drive signals from the respective drivers thereto on the basis of object information acquired by an object information acquisition unit 430, to be described below, which serves as a function unit of the hand control device 43. The arm control unit 420 then moves the arm mechanism 3 by controlling the respective motors whereby the hand mechanism 2 is moved to a predetermined gripping position suitable for gripping the object. Further, each of the motors provided in the joint portions 30a, 30b, 30c, 30d, 30e, 30f of the arm mechanism 3 is provided with an encoder (not shown) for detecting state quantities (a rotation position and a rotation speed of the rotary shaft of the motor, and so on) relating to the rotation state of the corresponding motor. The state quantities of the motors, detected by the encoders of the respective motors, are input into the motor state quantity acquisition unit 421 of the arm control device 42. Then, on the basis of the state quantities of the respective motors, input into the motor state quantity acquisition unit 421, the arm control unit 420 servo-controls the respective motors so that the hand mechanism 2 moves to the above-mentioned predetermined gripping position, for example.

Further, the hand control device 43 is configured to include a plurality of drivers that generate drive signals used to drive the motors provided in the hand mechanism 2 and to supply the drive signals from the respective drivers to the corresponding motors. The hand control device 43 also includes a computer having an arithmetic processing device and a memory. Further, as function units, the hand control device 43 includes the object information acquisition unit 430, a hand control unit 431, a motor state quantity acquisition unit 432, and a sensor information acquisition unit 433. These function units are formed by executing a predetermined control program in the computer included in the hand control device 43.

The object information acquisition unit 430 acquires object information, which is information relating to an object to be gripped by the hand mechanism 2. Here, the object information includes information relating to the shape, dimensions, and position of the object, information indicating the surrounding environment of the object (information relating to items other than the object existing on the periphery of the object, for example information relating to the shape of a container housing the object or a row of objects in the container), and so on. The object information acquisition unit 430 may also acquire object information input by a user. Further, when a visual sensor for capturing an image that includes the object is provided, the object information acquisition unit 430 may acquire object information from an image captured by the visual sensor.

Furthermore, the hand control unit 431 controls the first motors 51, the second motors 52, and the third motors 53 for driving the respective finger portions 21 of the hand mechanism 2 by supplying the drive signals from the respective drivers thereto on the basis of the object information acquired by the object information acquisition unit 430. For example, the hand control unit 431 controls the first motors 51, the second motors 52, and the third motors 53 of the hand mechanism 2 in order to grip the object using the hand mechanism 2, which has been moved to the predetermined gripping position as a result of the control executed on the arm mechanism 3 by the arm control unit 420. Further, the first motors 51, the second motors 52, and the third motors 53 of the hand mechanism 2 are each provided with an encoder (not shown) for detecting state quantities (the rotation position and rotation speed of the rotary shaft of the motor, and so on) relating to the rotation state of the corresponding motor. The state quantities of the motors 51, 52, 53, detected by the encoders of the motors 51, 52, 53, are input into the motor state quantity acquisition unit 432 of the hand control device 43. Then, on the basis of the state quantities of the motors 51, 52, 53, input into the motor state quantity acquisition unit 432, the hand control unit 431 servo-controls the motors 51, 52, 53 of the respective finger portions 21 so that the object is gripped by the plurality of finger portions 21, for example.

The hand control device 43 also includes the sensor information acquisition unit 433. Detection signals from the plurality of pressure sensors 70 provided on the first finger link portion 211 of each finger portion 21 of the hand mechanism 2 are input into the sensor information acquisition unit 433. On the basis of the detection signals from the pressure sensors 70, acquired by the sensor information acquisition unit 433, the hand control unit 431 can detect contact between the finger portions 21 and the object, and on the basis of corresponding detection signals, the hand control unit 431 can also control the motors 51, 52, 53 of the respective finger portions 21.

### Functions of Finger Portions

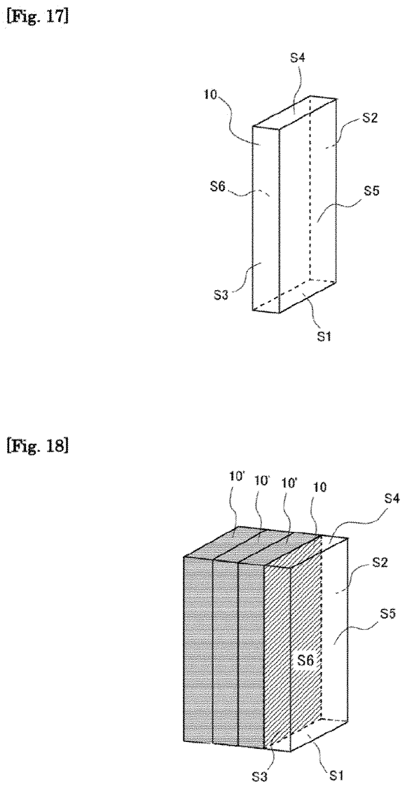

Next, functions exhibited by the finger portions 21 when an object is gripped by the hand mechanism 2 will be described. Here, FIG. 17 is a view showing an example of the shape of an object 10 to be gripped by the hand mechanism 2. Further, FIG. 18 is a view showing a state in which a plurality of objects 10 (10′) are arranged side by side. As shown in FIGS. 17 and 18, the object 10 is a rectangular parallelepiped having six surfaces (S1 to S6). Note, however, that the shape of the object 10 shown in FIG. 17 is merely an example, and the shape of the object gripped by the hand mechanism 2 is not limited to a rectangular parallelepiped.

Here, when the object 10 is to be gripped by the hand mechanism 2, at least two of the six surfaces of the object 10 must be set as predetermined gripping surfaces, and one of the finger portions 21 of the hand mechanism 2 must be brought into contact with each of the predetermined gripping surfaces so that the object 10 is clamped between the finger portions 21. A case in which the object 10 is gripped using the two surfaces S5, S6 having the largest surface area, among the six surfaces of the object 10, as the predetermined gripping surfaces will be described below.

When an attempt is made to grip the object 10 using the hand mechanism 2 with the surfaces S5, S6 of the object 10 set as the predetermined gripping surfaces, the surfaces S5, S6 must both be exposed so as to each be contactable by one of the finger portions 21 of the hand mechanism 2. As shown in FIG. 18, however, in a state where a plurality of objects 10 (10′) to be gripped successively by the hand mechanism 2 are arranged side by side in contact with each other, a predetermined gripping surface of the object 10 may be disposed in contact with the adjacent object 10′. In FIG. 18, the gripping surface S6, of the two predetermined gripping surfaces S5, S6 of the object 10, is in contact with the adjacent object 10′. In this case, the gripping surface S6 of the object 10 is not exposed. Hence, when the object 10 remains in the state shown in FIG. 18, the finger portions 21 of the hand mechanism 2 cannot be brought into contact with the gripping surface S6 of the object 10, and as a result, the object 10 cannot be gripped by the hand mechanism 2.

In this embodiment, therefore, when the object 10 is to be gripped by the hand mechanism 2 in a situation such as that described above, first, the attitude of, the object 10 is altered by one finger portion functioning as a state-altering finger portion, among the four finger portions 21 of the hand mechanism 2. The object 10 is then gripped by the three finger portions, among the four finger portions 21 of the hand mechanism 2, other than the finger portion functioning as the state-altering finger portion, these three finger portions functioning as gripping finger portions.

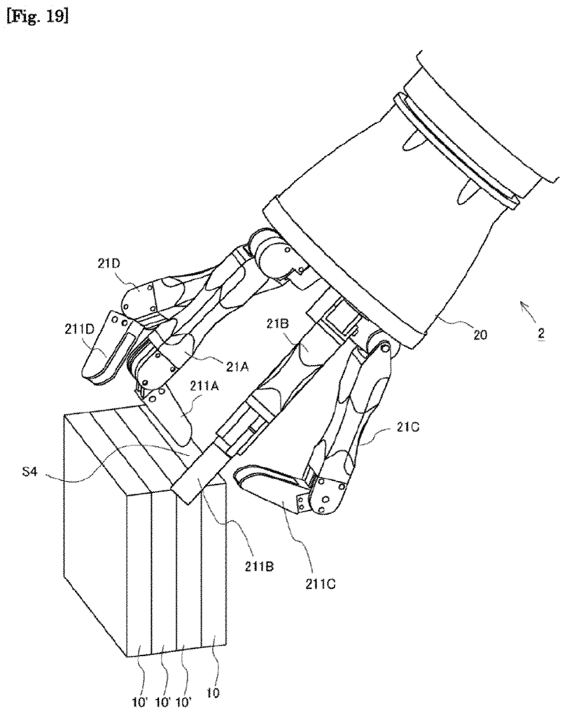

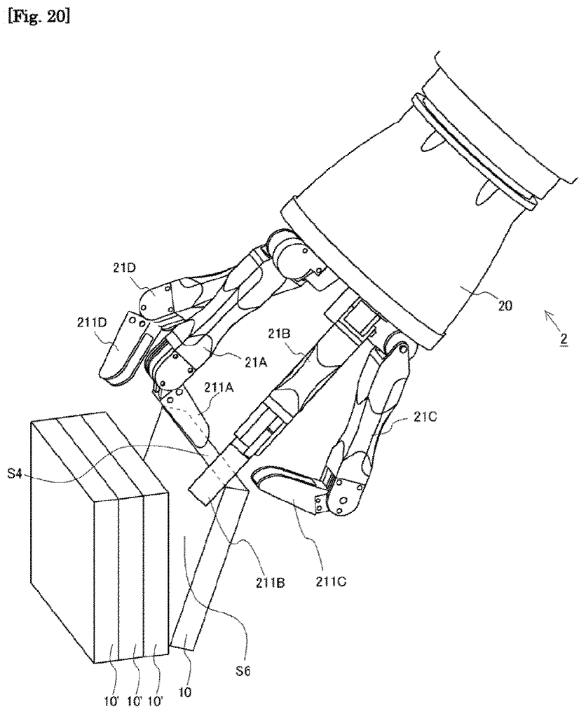

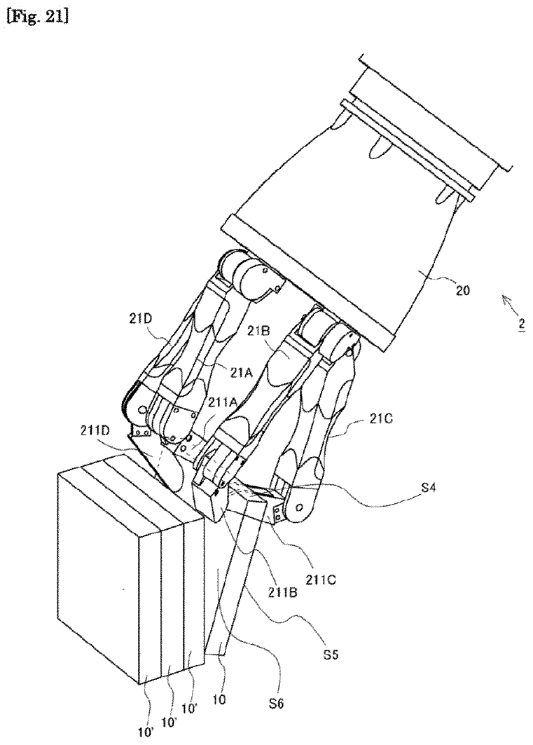

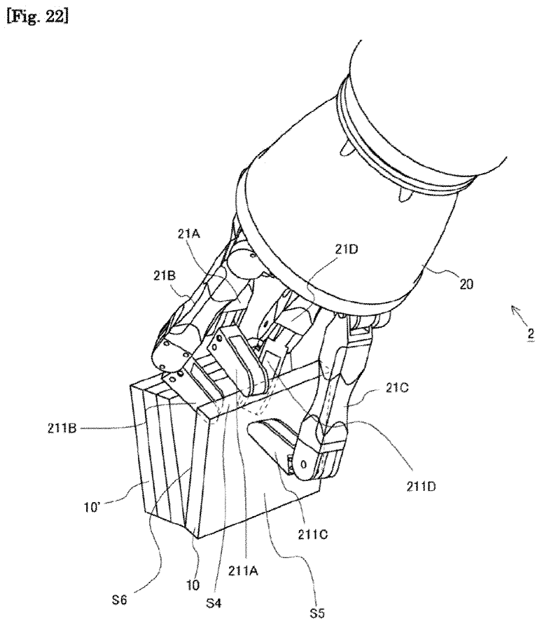

Procedures implemented in this embodiment to grip the object 10 disposed in the state shown in FIG. 18 using the hand mechanism 2 will be described in detail below on the basis of FIGS. 19 to 22. Note that here, the finger portions 21 of the hand mechanism 2 will be referred to respectively as a first finger portion 21A, a second finger portion 21B, a third finger portion 21C, and a fourth finger portion 21D. Further, a case in which the first finger portion 21A is set as the finger portion functioning as the state-altering finger portion and the second to fourth finger portions 21B, 21C, 21C are set as the finger portions functioning as the gripping finger portions will be described below. FIGS. 19 and 20 are views showing an operation to alter the attitude of the object 10 using the first finger portion 21A of the hand mechanism 2. Further, FIGS. 21 and 22 are views showing a state in which the object 10 has been gripped by the second finger portion 21B, the third finger portion 21C, and the fourth finger portion 21D of the hand mechanism 2. The procedures to be described below, which are implemented by the hand mechanism 2 to grip the object 10, are realized by controlling the arm mechanism 3 with the arm control device 42 to move the hand mechanism 2 to a predetermined gripping position and then controlling the hand mechanism 2 with the hand control device 43.

As shown in FIG. 18, even when the object 10 is disposed in a state where the gripping surface 86 forms a contact surface that contacts the adjacent object 10′, the upper surface S4 thereof is exposed. Therefore, the finger portions 21 of the hand mechanism 2 can be brought into contact with the upper surface 84 of the object 10. Hence, in this embodiment, as shown in FIG. 19, first, a first finger link portion 211A of the first finger portion 21A, which functions as the state-altering finger portion when the current object 10 is to be gripped, is brought into contact with the upper surface 84 of the object 10. Note that at the stage where the first finger portion 21A has been brought into contact with the upper surface 84 of the object 10, the other finger portions 21B, 21C, 21D of the hand mechanism 2 do not contact the object 10.

Here, the contact between the first finger link portion 211A and the object 10 shown in FIG. 19 is detected by the pressure sensors 70 mounted on the first finger link portion 211A. At this time, even in a state where the dead zone covering portion of the flexible cover 211a is in contact with the object 10 but the sensor element covering portion of the flexible cover 211a is not in contact with the object 10, the contact between the first finger link portion 211A and the object 10 can be detected by at least one of the two sensor elements 70b respectively disposed adjacent to the dead zone R. When the contact between the first finger link portion 211 and the object 10 is detected in this manner, a corresponding detection signal is input into the sensor information acquisition unit 433 of the hand control device 43, and as a result, the hand control device 43 can ascertain the state of contact between the first finger link portion 211A and the object 10 accurately.

When the first finger portion 21A is caused to function as the altering finger portion, as shown in FIGS. 18 and 19, for example, the tip end part (the so-called fingertip part) of the first finger link portion 211A mainly contacts the object 10. Accordingly, the dead zone covering portion between the pressure sensor 700 disposed on the extending-side wall surface 216 of the first finger link portion 211A and the pressure sensor 701 disposed furthest toward the tip end portion side on the bending-side wall surface 215 of the first finger link portion 211A may come into contact with the object 10. In this case, as shown in FIG. 15B, the flexible cover 211a yields while pressing the sensor element 70b of at least, one of these two pressure sensors 700, 701, and as a result, the contact between the first finger link portion 211A and the object 10 can be detected.

Note that the pressure detected by the pressure sensor 700 and the pressure sensor 701 when the dead zone covering portion contacts the object 10 tends to be smaller than the pressure detected by the pressure sensor 700 or the pressure sensor 701 when the sensor element covering portion contacts the object. Therefore, when the pressure detected by the pressure sensor 700 and the pressure sensor 701 is smaller than a first predetermined value in a case where the first finger portion 21A is caused to function as the altering finger portion, the hand control device 43 may determine that the dead zone covering portion between the pressure sensor 700 and the pressure sensor 701 is in contact, with the object 10. The “first, predetermined value” in this case is a value that can be detected by the pressure sensors 700, 701 when the sensor element covering portion contacts the object 10 in a case where the first finger portion 21A is caused to function as the altering finger portion. By employing this method, the contact position in which the first finger portion 21A contacts the object can be specified even when the object 10 contacts the dead zone covering portion of the first finger portion 21A.

Furthermore, when the first finger portion 21A is caused to function as the altering finger portion, as shown in FIGS. 18 and 19, and the two pressure sensors 700, 701 detect pressure simultaneously, the hand control device 43 may determine that a region of the flexible cover 211a including at least the dead zone covering portion between the pressure sensor 700 and the pressure sensor 701 is in contact with the object 10. In other words, when the two pressure sensors 700, 701 detect pressure simultaneously, the hand control device 43 may determine that at least the dead zone covering portion of the flexible cover 211a is in contact with the object 10. Here, a case in which a region that includes the dead zone covering portion and extends from the sensor element covering portion covering the sensor element 70b of the pressure sensor 700 to the sensor element covering portion covering the sensor element 70b of the pressure sensor 701 is in contact with the object 10 (in other words, a case in which the object contacts the flexible cover 211a so as to extend across the two pressure sensors 700, 701) is also envisaged as a case in which the pressure sensor 700 and the pressure sensor 701 detect pressure simultaneously, in addition to a case in which only the dead zone covering portion between the pressure sensor 700 and the pressure sensor 701 is in contact with the object 10. In all of these cases, at least, the dead zone covering portion is in contact with the object 10. Hence, the contact position in which the first finger portion 21A contacts the object can be specified roughly even when a region including at least the dead zone covering portion between the pressure sensor 700 and the pressure sensor 701 is in contact with the object 10 in a case where the first finger portion 21A is caused to function as the altering finger portion.

Here, when the functions of the first finger portion 21A are particularized to the state-altering finger portion, as described above, pressure sensors need only be mounted in two locations, namely the extending-side wall surface 216 of the first finger link portion 211A and the tip end portion side of the bending-side wall surface 215 of the first finger link portion 211 (in other words, only the pressure sensor 700 and the pressure sensor 701 need be mounted on the first finger link portion 211).

Once contact between the fingertip part of the state-altering finger portion (the first finger portion 21A) and the object 10 has been detected using the various methods described above, the hand control device 43 can control the hand mechanism 2 so as to alter the state of the object. More specifically, as shown in FIG. 20, in a state where the first finger link portion 211A of the first finger portion 21A is in contact with the upper surface S4 of the object 10, the hand control device 43 tilts the object 10 forward using the first finger portion 21A. In other words, the object 10 can be tilted in a direction for separating the gripping surface S6 of the object 10 from the adjacent object 10′. By altering the attitude of the object 10 using the first finger portion 21A functioning as the state-altering finger portion in this manner, an interval between the object 10 and the adjacent object 10′ can be widened. Thus, the gripping surface S6 of the object 10 can be exposed. As a result, the finger portions of the hand mechanism 2 other than the first finger portion 21A can be brought into contact, not only with the other gripping surface S5 of the object 10 but also the gripping surface S6. Note that this state of the object 10, in which the finger portions 21 of the hand mechanism 2 can be brought into contact with both of the predetermined gripping surfaces S5, S6 of the object 10, will be referred to hereafter as a “predetermined grippable state”.

Next, as shown in FIGS. 21 and 22, once the attitude of the object 10 has been set in the predetermined grippable state by tilting the object 10 using the first finger portion 21A, the object 10 is gripped by the second finger portion 21B, the third finger portion 21C, and the fourth finger portion 21D that function as the gripping finger portions when the current object 10 is gripped. At this time, in FIGS. 21 and 22, a first finger link portion 211B of the second finger portion 21B and a first finger link portion 211D of the fourth finger portion 21D are brought into contact with the gripping surface S6 of the object 10, which is exposed after the attitude, of the object 10 is altered. Meanwhile, a first finger link portion 211C of the third finger portion 21C is brought into contact with the other gripping surface S5 of the object 10. Note, however, that it is not always necessary to bring two finger portions into contact with the gripping surface S6 of the object 10. In other words, the object 10 may also be gripped by bringing one finger portion into contact with the gripping surface S6 of the object 10 and bringing two finger portions into contact with the other gripping surface S5 of the object 10. Alternatively, the object 10 may be gripped in a state where one finger portion contacts the gripping surface S6 of the object 10 and one finger portion contacts the other gripping surface S5 of the object 10. In other words, in a hand mechanism having three finger portions, the object may be gripped by causing one of the finger portions to function as the state-altering finger portion and causing the remaining two finger portions to function as the gripping finger portions.

Here, contact between the object 10 and each of the first finger link portion 211B of the second finger portion 21B, the first finger link portion 211C of the third finger portion 21C, and the first finger link portion 211D of the fourth finger portion 21D is detected by the pressure sensors 70 provided on each of the first finger link portions 211B, 211C, and 211D. At this time, even in a state where the dead zone covering portions of the flexible covers 211a on the first finger link portions 211B, 211C, and 211D contact the object 10 but the sensor element covering portions of the flexible covers 211a do not contact the object 10, contact between the first finger link portions 211B, 211C, 211D and the object 10 can be detected by at least one of the two sensor elements 70b respectively disposed adjacent to the dead zone R, and therefore the hand control device 43 can ascertain the state of contact between the hand mechanism 2 and the object 10 accurately.

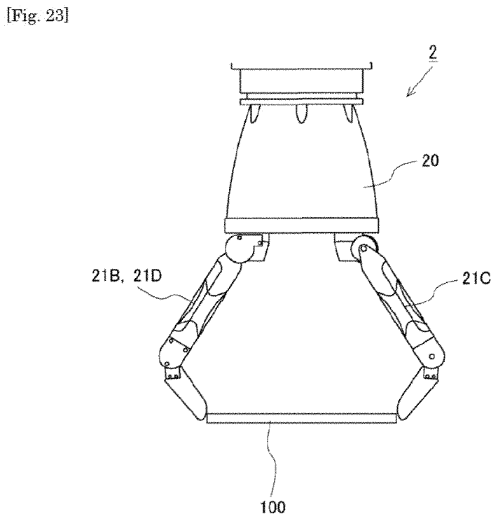

In a case where the second finger portion 21B, the third finger portion 21C, and the fourth finger portion 21D are caused to function as the gripping finger portions, as shown in FIGS. 21 and 22, for example, the intermediate parts of the bending-side wall surfaces 215 of the respective first finger link portions 211B, 2110, 211D mainly contact the object 10. Accordingly, the dead zone covering portion between the pressure sensor 703 disposed furthest toward the base end portion side and the pressure sensor 702 disposed intermediately on the bending-side wall surface 215 of each of the first finger link portions 211B, 211C, 211D may come into contact with the object 10. In particular, in a situation where respective corner portions of an object 100 having a rectangular cross-section contact the second finger portion 21B, the third finger portion 21C, and the fourth finger portion 21D, as shown in FIG. 23, the dead zone covering portion between the pressure sensor 703 disposed furthest toward the base end portion side and the pressure sensor 702 disposed intermediately on the bending-side wall surface 215 of each of the first finger link portions 211B, 211C, and 211D may come into contact with the object 10. Likewise in this case, as shown in FIG. 15B, the flexible cover 211a yields while pressing the sensor element 70b of at least one of the two pressure sensors 702, 703, and as a result, the contact between the first finger link portions 211B, 211C, 211D and the object 10 can be detected.

Note that similarly to the case of the pressure sensors 700, 701, described above, the pressure detected by the pressure sensor 702 and the pressure sensor 703 when the dead zone covering portion contacts the object 10 tends to be smaller than the pressure detected by the pressure sensor 702 or the pressure sensor 703 when the sensor element covering portion contacts the object. Therefore, when the pressure detected by the pressure sensor 702 and the pressure sensor 703 is smaller than a second predetermined value in a case where the second finger portion 21B, the third finger portion 21C, and the fourth finger portion 21D are caused to function as the gripping finger portions, the hand control device 43 may determine that the dead zone covering portion between the pressure sensor 702 and the pressure sensor 703 is in contact with the object 10. The “second predetermined value” in this case is a value that can be detected by the pressure sensors 702, 703 when the sensor element covering portion contacts the object 10 in a case where the second finger portion 21B, the third finger portion 21C, and the fourth finger portion 21D are caused to function as the gripping finger portions. By employing this method, the contact positions in which the second finger portion 21B, the third finger portion 21C, and the fourth finger portion 21D respectively contact the object can be specified even when the object 10 contacts the dead zone covering portions of these finger portions 21B, 21C, 21D.

Furthermore, when the second finger portion 21B, the third finger portion 21C, and the fourth finger portion 21D are caused to function as the gripping finger portions, as shown in FIGS. 21 and 22, and the pressure sensors 702, 703 of each of the finger portions 21B, 21C, 21D detect pressure simultaneously, the hand control device 43 may determine that a region of the flexible cover 211a including at least the dead zone covering portion between the pressure sensor 702 and the pressure sensor 703 is in contact with the object. According to this method, the contact positions in which the second finger portion 21B, the third finger portion 21C, and the fourth finger portion 21D respectively contact the object can be specified roughly even when a region including at least the dead zone covering portion between the pressure sensor 702 and the pressure sensor 703 is in contact with the object 10 in a case where the second finger portion 21B, the third finger portion 21C, and the fourth finger portion 21D are caused to function as the gripping finger portions.

With the hand mechanism 2 according to this embodiment, as described above, even when the dead zone covering portion of each of the finger portions 21 contacts the object 10 but the sensor element covering portion does not contact, the object 10 in a case where the object 10 is to be gripped by the hand mechanism 2, contact between the finger portion 21 and the object 10 can be detected by at least one of the sensor elements 70b respectively disposed adjacent to the dead zone R. Accordingly, the hand control device 43 can ascertain the state of contact between each finger portion 21 and the object 10 accurately, and as a result, the object 10 can be gripped by the hand mechanism 2 in a more appropriate attitude. Even when control is executed to alter the attitude of the object 10 to the predetermined grippable state by causing one of the four finger portions 21 (in the example described above, the first finger portion 21A) to function as the state-altering finger portion in a specific situation in which the object 10 is disposed in contact with another object 10′ so that a predetermined gripping surface of the object 10 is not exposed, meaning that if the object 10 remains in this state, the finger portions 21 of the hand mechanism 2 cannot be brought into contact with the predetermined gripping surface of the object 10, the state of contact and the contact position between the state-altering finger portion and the object 10 can be recognized accurately, and as a result, the control can be executed more precisely. Furthermore, even when control is executed to expose the predetermined gripping surface of the object 10 that is in contact with the other object 10′ by altering the attitude of the object 10 to the predetermined grippable state using the finger portion functioning as the state-altering finger portion and then clamping the object 10 using the finger portions (in the example described above, the second finger portion 21B, the third finger portion 21C, and the fourth finger portion 21D) other than the finger portion functioning as the state-altering finger portion, i.e.

the finger portions functioning as the gripping finger portions, the states of contact and the contact positions between the gripping finger portions and the object can be recognized more accurately, and as a result, the control can be executed more precisely. Moreover, when the flexible cover 2110a is formed from a member in which the friction coefficient of the outer surface of the flexible cover 211a is larger than the respective friction coefficients of the outer wall surface of the first finger link portion 211 and the outer surface of the insulating film 70c, frictional force generated when the object is gripped by the hand mechanism 2 can be increased, and as a result, the object can be gripped more reliably.

### Second Embodiment

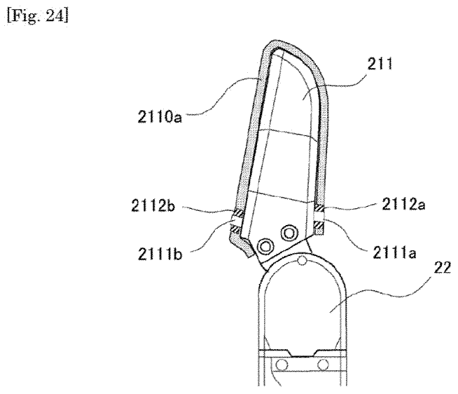

Next, a second embodiment of the present invention will be described on the basis of FIGS. 24 to 27. Here, configurations that differ from the first embodiment will be described, while description of similar configurations will be omitted.

In the example described above in the first embodiment, a part of the outer wall surface of the first finger link portion 211 is covered by adhering the sheet-form flexible cover 211a from the extending-side wall surface 216 (the back portion) to the bending-side wall surface 215 (the abdominal portion) of the first finger link portion 211 so as to cover the plurality of pressure sensors 70 and the outer wall surface of the first finger link portion 211 on the periphery thereof. In the example to be described in this embodiment, on the other hand, a flexible cover 2110 formed in a bag shape that is closed on the tip end portion side and open on the base end portion side is placed over the first finger link portion 211 so as to cover the entire outer wall surface of the first finger link portion 211.

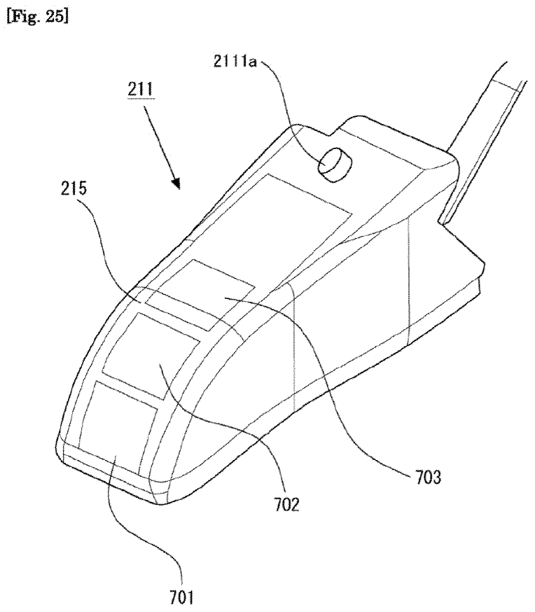

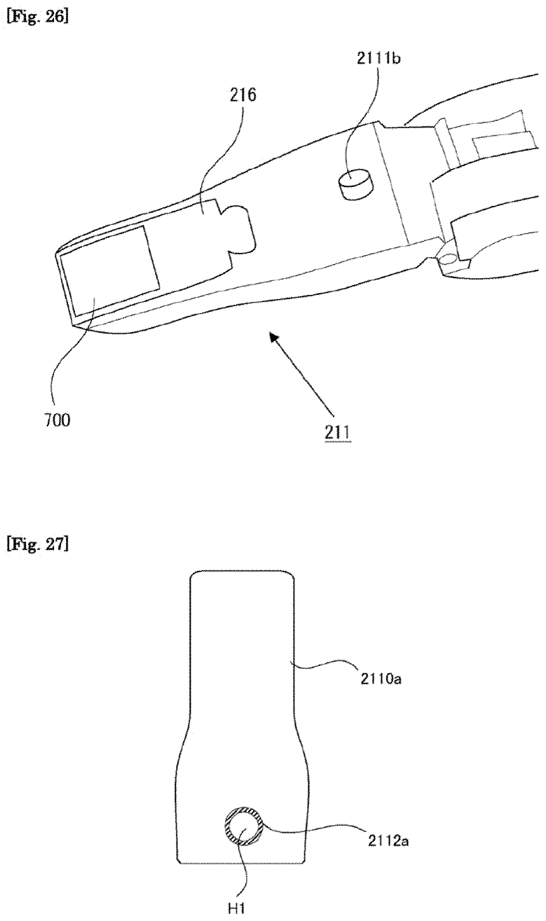

FIG. 24 is a view showing a state in which the flexible cover according to this embodiment is placed on the first finger link portion. FIG. 25 is a perspective view showing a configuration of the abdominal portion (the extending-side wall surface 216) of the first finger link portion 211 according to this embodiment. FIG. 26 is a per view showing a configuration of the back portion (the bending-side wall surface 215) of the first finger link portion 211 according to this embodiment. FIG. 27 is a front view of the flexible cover 2110a according to this embodiment (a plan view of the side covering; the bending-side wall surface 215 of the first finger link portion 211).

As shown in FIG. 24, the flexible cover 2110a according to this embodiment is formed in a so-called finger sack shape and placed over the first finger link portion 211 so as to cover the entire outer wall surface of the first finger link portion 211. More specifically, the flexible cover 2110a is formed in a bag shape that is closed on the tip end portion side and open on the base end portion side. At this time, the flexible cover 2110 is formed such that a length from the tip end to the base end of the flexible cover 2110a is equal to or slightly shorter than a length from the tip end to the base end of the first finger link portion 211. Further, the flexible cover 2110a is formed such that the inner shape of the flexible cover 2110a is substantially identical to the outer shape of the first finger link portion 211. Thus, in a state where the flexible cover 2110a is placed on the first finger link portion 211, the inner wall surface of the flexible cover 2110a closely contacts the outer wall surface of the first finger link portion 211. Note that the flexible cover 2110a may be formed from a member in which the friction coefficient of the outer surface of the flexible cover 2110a is larger than the respective friction coefficients of the outer wall surface of the first finger link portion 211 and the outer surface of the insulating film 70c.

Further, the first finger link portion 211 according to this embodiment includes projections 2111a, 2111b (corresponding to a first fitting portion according to the present, invention) formed in two locations on the outer wall surface of the first finger link portion 211, namely the bending-side wall surface 215 (the abdominal portion) and the extending-side wall surface 216 (the back portion). More specifically, as shown in FIG. 25, the substantially columnar projection 2111a is formed in a site on the bending-side wall surface 21a of the first finger link portion 211 further toward the base end portion side than the three pressure sensors 701, 702, 703. Further, as shown in FIG. 26, the substantially columnar projection 2111b is formed in a site on the extending-side wall surface 218 of the first finger link portion 211 further toward the base end portion side than the pressure sensor 700.

Meanwhile, the flexible cover 2110a according to this embodiment includes eyelet members 2112a, 2112b (corresponding to a second fitting member according to the present invention) provided in sites of the flexible cover 2110a corresponding to the two projections 2111a, 2111b. More specifically, the eyelet member 2112a is attached to a site, in the part of the flexible cover 2110a that covers the bending-side wall surface 215 (the abdominal portion) of the first finger link portion 211, corresponding to the projection 2111a on the first finger link portion 211. As shown in FIG. 27, the eyelet member 2112a is a ring-shaped member having a substantially columnar through hole H1 formed in a central part thereof, and is formed from resin, metal, or the like, for example. Note that the through hole H1 in the eyelet member 2112a is formed to have a diameter that equal to or slightly larger than the diameter of the projection 2111a on the first finger link portion 211. Further, the eyelet member 2112b is attached to a site, in the part of the flexible cover 2110a that covers the extending-side wall surface 216 (the back portion) of the first finger link portion 211, corresponding to the projection 2111b on the first finger link portion 211. The eyelet member 2112b, similarly to the eyelet member 2112a, is a ring-shaped member having a substantially columnar through hole formed in a central part thereof. The through hole in the eyelet member 2112b is formed to have a diameter that equal to or slightly larger than the diameter of the projection 2111b on the first finger link portion 211.

When the flexible cover 2110a configured as described above is placed over the first finger link portion 211, as shown in FIG. 24, the flexible cover 2110a is to be placed over the first finger link portion 211 so that the projection 2111a on the bending-side wall surface 215 of the first finger link portion 211 is fitted into the through hole in the eyelet member 2112a in the flexible cover 2110a and the projection 2111b on the extending-side wall surface 216 of the first finger link portion 211 is fitted into the through hole in the eyelet member 2112b in the flexible cover 2110a. In so doing, the flexible cover 2110a is positioned relative to the first finger link portion 211 so that when the hand mechanism 2 performs the various gripping operations described in the first embodiment, positional deviation of the flexible cover 2110a is suppressed. In particular, When the flexible cover 2110a is formed from a member in which the friction coefficient of the outer surface is larger than the respective friction coefficients of the outer wall surface of the first finger link portion 211 and the outer surface of the insulating film 70c, the frictional force generated when the object is gripped by the hand mechanism 2 increases, with the result that the object can be gripped more reliably, but on the other hand, force for moving the flexible cover 2110a in a positional deviation direction may also increase. Even in this case, however, the projections 2111a, 2111b are fitted into the through holes in the eyelet members 2112a, 2112b, and therefore positional deviation of the flexible cover 2110a can be suppressed. By suppressing positional deviation of the flexible cover 2110a when the hand mechanism 2 performs a gripping operation, the inner wall surface of the flexible cover 2110a can be kept in close contact with the outer wall surface of the first finger link portion 211. Thus, in a state where the dead zone covering portion of the flexible cover 2110a contacts the object but the sensor element covering portion of the flexible cover 2110a does not contact the object, the flexible cover 2110a in the vicinity of the dead zone covering portion can yield while pressing at least one of the two sensor elements 70b respectively positioned adjacent to the dead zone. As a result, similar effects to those realized by the flexible cover 211a according to the first embodiment can be acquired. Furthermore, with the flexible cover 2110a according to this embodiment, the entire outer wall surface of the first finger link portion 211 is covered, and therefore soiling and wear on the first finger link portion 211 and the pressure sensors 70 can be suppressed.

Note that in the example described in this embodiment, the projections are provided on the first finger link portion side and the eyelet members having through holes into which the projections can be fitted are provided on the flexible cover side. Instead, however, projections may be provided on the flexible cover side and eyelet members having through holes into which the projections can be fitted may be provided on the first finger link portion side. In this case also, similar effects to those realized by this embodiment can be acquired.

Moreover, in the example described in this embodiment, the flexible cover is positioned by a combination of a projection and a hole in two locations, namely on the abdominal portion side and the back portion side of the first finger link portion, but in cases such as when the hand mechanism is used in an application where comparatively little farce is generated for moving the flexible cover in the positional deviation direction during the gripping operation performed by the hand mechanism, the flexible cover may be positioned by a combination of a projection and a hole in a single location, i.e. either on the abdominal portion side or the back portion side of the first finger link portion.

Note that although in the example described in this embodiment, the flexible cover is positioned by a combination of a substantially columnar projection and an eyelet member having a through hole into which the projection can be fitted, the present invention is not limited thereto, and instead, for example, the flexible cover may be positioned using a snap button constituted by a combination of a male snap and a female snap. Alternatively, the flexible cover may be positioned by attaching one part of a hook-and-loop fastener to the base end portion side (the vicinity of the open part) on the inner surface of the flexible cover, attaching the other part of the hook-and-loop fastener to a site, on the outer wall surface of the first finger link portion, corresponding to the aforesaid part of the hook-and-loop fastener, and fitting together the two parts of the hook-and-loop fastener.

### Other Embodiments

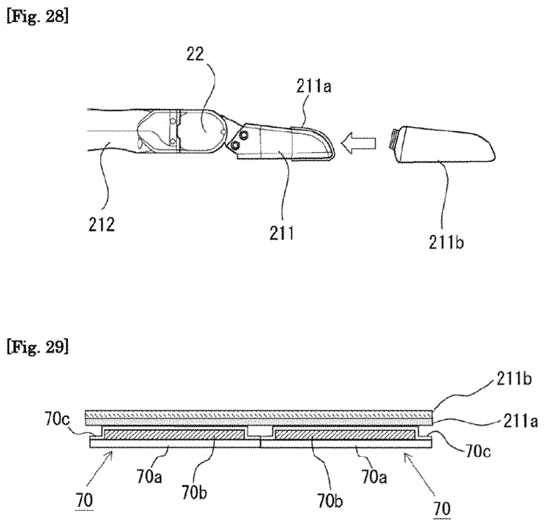

In the example described above in the first embodiment, the flexible cover 211a is attached to each finger portion 21, but in addition to the flexible cover 211a, a membranous protective cover may be attached to each finger portion 21 so as to cover the flexible cover 211a. For example, as shown in FIGS. 28 and 29, after adhering the flexible cover 211a to the first finger link portion 211 of each finger portion 21, a bag-shaped (finger sack-shaped) protective cover 211b that is closed on the tip end portion side and open on the base end portion side and has an inner shape that is substantially identical to the outer shape of the first finger link portion 211 is placed over the first finger link portion 211 so that the plurality of pressure sensors 70 are covered by a two-layer cover 211a, 211b. At this time, the protective cover 211b is formed from a member in which the friction coefficient of the outer surface of the protective cover 211b is larger than the respective friction coefficients of the outer wall surface of the first finger link portion 211 and the outer surface of the flexible cover 211a and a member that is less flexible than the flexible cover 211a. When the protective cover 211b formed in this manner is placed over the first finger link portion 211, wear occurring on the flexible cover 211a when the object is gripped by the hand mechanism 2 can be suppressed. Further, when the protective cover 211b formed in this manner is placed over the first finger link portion 211, the frictional force generated when the object is gripped by the hand mechanism 2 can be increased, and as a result, the object can be gripped more reliably Moreover, the protective cover 211b can be attached to and detached from the flexible cover 211a freely, and therefore, when the protective cover 211b becomes worn, the protective cover 211b can be replaced with a new one. In addition, when the protective cover 211b formed in this manner is placed over the first finger link portion 211, the pressure sensors 70 are covered by a two-layer cover, and therefore the thickness of the cover is greater than when a single-layer cover is formed from the flexible cover 211a alone. Hence, when the dead zone covering portion contacts the object, the pressure that is transmitted to the dead zone covering portion from the object is transmitted more easily to at least one of the sensor elements 70b that are respectively adjacent, to the dead zone. As a result, the contact between the dead zone covering portion and the object can be detected more accurately.

Note that in the example shown in FIG. 28, the protective cover 211b is formed in the shape of a finger sack covering only the first finger link portion 211 of each finger portion 21, but the protective cover 2111b may be formed in the shape of a glove covering the base portion 20 and the entirety of the finger portions 21, including the first finger link portions 211 and the second finger link portions 212. When the protective cover is formed in a glove shape, soiling of the hand mechanism 2 can be suppressed, and dust and the like can be prevented from entering through gaps in the respective joint portions and so on.

Furthermore, the protective cover is not, limited to being formed so as to be freely attachable to and detachable from the flexible cover 211a, and instead, for example, a sheet-form protective cover formed in a substantially identical shape to the flexible cover 211a may be adhered to the surface of the flexible cover 211a. With this configuration, when the protective cover 211b adhered to the flexible cover 211a becomes worn, either the protective cover 211b can be replaced with a new protective cover 211b or the entire configuration, including the protective cover 211b, can be replaced with a new one.

### REFERENCE SIGNS LIST

1 Robot arm
2 Hand mechanism
20 Base portion
21 Finger portion
22 First joint portion
23 Second joint portion
211 First finger link portion
211a, 2110b Flexible cover
211b Protective cover
2111a, 2111b Projections
2112a, 2112b Eyelet members
212 Second finger link portion
213 Base end portion
3 Arm mechanism
30a First joint portion
30b Second joint portion
30c Third joint portion
30d Fourth joint portion
30e Fifth joint portion
30f Sixth joint portion
31 First arm link portion
32 Second arm link portion
33 Third arm link portion
34 Fourth arm link portion
35 Fifth arm link portion
36 Connecting member
4 Support portion
42 Arm control device
420 Arm control unit
421 Motor state quantity acquisition unit
43 Hand control device
430 Object information acquisition unit
431 Hand control unit
432 Motor state quantity acquisition unit
433 Sensor information acquisition unit
51 First motor
52 Second motor
53 Third motor
61, 62 Bevel gears
63 Worm wheel
64 Worm
65, 66 Gears
70 Pressure sensor
70a Base material
70b Sensor element
70c Insulating film

1. A hand mechanism that includes a plurality of finger portions and grips an object using the finger portions, comprising:
a plurality of pressure sensors arranged on an outer wall surface of at least one of the plurality of finger portions; and
a flexible cover formed from a flexible, membranous member and provided on the finger portion on which the plurality of pressure sensors are disposed in order to cover the plurality of pressure sensors.

2. The hand mechanism according to claim 1, wherein the plurality of pressure sensors are arranged on a tip end portion side of the finger portion, and
the flexible cover is formed in a bag shape that is closed on a tip end portion side and open on a base end portion side and placed over the finger portion so as to cover the tip end portion side of the finger portion.

3. The hand mechanism according to claim 2, further comprising:
a first fitting portion provided on the outer wall surface of the finger portion in a position further toward the base end portion side than the plurality of pressure sensors and in at least one of a site on an abdominal portion side of the finger portion and a site on a back portion side of the finger portion; and
a second fitting portion that is provided in a site of the flexible cover corresponding to the first fitting portion on the finger portion and can be fitted to the first fitting portion,
wherein, in a state where the flexible cover is placed over the finger portion, the flexible cover is positioned by fitting the first fitting portion and the second fitting portion to each other.

4. The hand mechanism according to claim 3, wherein one of the first fitting portion and the second fitting portion, includes a projection, and the other of the first fitting portion and the second fitting portion includes a hole that can be fitted to the projection.

5. The hand mechanism according to claim 1, wherein the flexible cover is formed in sheet-form and adhered to the outer wall surface of the finger portion so as to cover the plurality of pressure sensors.

6. The hand mechanism according to claim 1, wherein the flexible cover is formed from a member having a larger friction coefficient than the outer wall surface of the finger portion.

7. The hand mechanism according to claim 1, wherein the hand mechanism includes three or more finger portions, and
when the object is to be gripped, at least one of the three or more finger portions functions as a state-altering finger portion for altering the attitude and/or the position of the object while contacting the object, and at least two of the finger portions other than the finger portion functioning as the state-altering finger portion function as gripping finger portions for gripping the object in a state where the attitude and/or the position has been altered by the state-altering finger portion.

8. A gripping system comprising:
the hand mechanism according to claim 1; and
a control device for controlling the hand mechanism when the object is gripped by the hand mechanism,
wherein, when at least one of two adjacent pressure sensors, among the plurality of pressure sensors, detects pressure, and the detected pressure is smaller than a predetermined value, the control device determines that a site of the flexible cover covering a gap between the two pressure sensors is in contact with the object.

9. A gripping system comprising:
the hand mechanism according to claim 1; and
a control device for controlling the hand mechanism when the object is gripped by the hand mechanism,
wherein, when two adjacent pressure sensors, among the plurality of pressure sensors, detect pressure, the control device determines that a region of the flexible cover including at least a site coveting a gap between the two pressure sensors is in contact with the object.

10. The gripping system according to claim 9, wherein the hand mechanism includes three or more finger portions and is configured such that a fingertip part of at least one of the three or more finger portions functions as a state-altering finger portion for altering the attitude and/or the position of the object while contacting the object,
two or more pressure sensors are arranged on the tip end portion side of the finger portion functioning as the state-altering finger portion so as to extend from a back portion to an abdominal portion of the finger portion, and
when two adjacent pressure sensors, among the two or more pressure sensors, detect pressure, the control device determines that a tip end part of the state-altering finger portion is in contact with the object.
